(19) United States
(12) Patent Application Publication
(10) Pub. No.: US 2026/0208575 A1
(43) Pub. Date: Jul. 23, 2026

(54) VEHICLE HAVING ACTIVE GRILLE SHUTTER ASSEMBLY

(71) Applicant: FCA US LLC, Auburn Hills, MI (US)

(72) Inventors: Uday K Mahakali, Auburn Hills, MI (US); Sreekanth Surapaneni, Auburn Hills, MI (US); Venkata K.M. Chagarlamudi, Auburn Hills, MI (US); Arturo Guzman-Magana, Auburn Hills, MI (US)

(21) Appl. No.: 19/027,512

(22) Filed: Jan. 17, 2025

(51) Int. Cl. B60K 11/08

(52) U.S. Cl. CPC B60K 11/085

(57) ABSTRACT

A vehicle including a vehicle body having a front end that defines an engine compartment for a propulsion system of the vehicle; a grille provided at the front end that is configured to permit air to enter the engine compartment; and an active grille shutter assembly provided between the grille and the engine compartment, wherein the active grille shutter assembly includes a conduit configured to receive pressurized air from a pump, a plurality of independently controllable air restriction bladders that are in fluid communication with the conduit and configured to receive the pressurized air from the conduit to inflate the air restriction bladders and either prevent the air from entering the engine compartment through the grille or reduce an amount of the air from entering the engine compartment through the grille.

### FIELD

The present disclosure relates to a vehicle having an active grille shutter assembly.

### BACKGROUND

This section provides background information related to the present disclosure which is not necessarily prior art.

Vehicle manufacturers are increasingly developing active grille shutter assemblies to improve the fuel efficiency of vehicles powered by internal combustion engines, and to improve the range of electrically powered vehicles. Active grille shutter assemblies are typically integrated into a grille assembly of the vehicle, and include adjustable vanes or louvers that open and close in response to engine cooling requirements, vehicle speed, and other factors. Thus, the airflow through the grille assembly and engine compartment can be dynamically controlled based on the operating conditions of the vehicle. The drawbacks of current active grille shutter assemblies, however, is that the assembly requires motors to actuate the louvers, which can increase the weight of the vehicle. Moreover, the use of louvers only permits a limited number of open and closed positions, and may be undesirably visible to customers. There is a need, therefore, for an improved active grille assembly that does not unnecessarily increase the weight of the vehicle and can be hidden from view when not in use.

### SUMMARY

This section provides a general summary of the disclosure, and is not a comprehensive disclosure of its full scope or all of its features.

According to a first aspect of the present disclosure, there is provided a vehicle that includes a vehicle body having a front end that defines an engine compartment for a propulsion system of the vehicle; a grille provided at the front end that is configured to permit air to enter the engine compartment; and an active grille shutter assembly provided between the grille and the engine compartment, wherein the active grille shutter assembly includes a conduit configured to receive pressurized air from a pump, a plurality of independently controllable air restriction bladders that are in fluid communication with the conduit and configured to receive the pressurized air from the conduit to inflate the air restriction bladders and either prevent the air from entering the engine compartment through the grille or reduce an amount of the air from entering the engine compartment through the grille.

According to the first aspect, each air restriction bladder includes a valve that is operable to permit and prevent the pressurized air from entering the respective air restriction bladder.

According to the first aspect, a controller may be in communication with and configured to control each of the valves and the pump.

According to the first aspect, the controller is configured to determine whether to open and close each of the valves and control operation of the pump based on a vehicle operating condition.

According to the first aspect, the vehicle operating condition is a velocity of the vehicle.

According to the first aspect, the vehicle operating condition is a temperature within the engine compartment.

According to the first aspect, each of the air restriction bladders are formed from a fabric material.

According to the first aspect, each of the air restriction bladders includes a return coil attached to the fabric material that is configured to return each of the air restriction bladders to a deflated state after the pressurized air is evacuated from the air restriction bladders.

According to the first aspect, each of the valves is a solenoid valve that is operable, based on an instruction received from the controller, to adjust an amount of the pressurized air that is permitted to enter the respective air restriction bladder.

According to the first aspect, each of the air restriction bladders, based on an instruction received by the respective valve from the controller, is movable from a deflated state to a partially inflated state, from a deflated state to a fully inflated state, from a partially inflated state to a fully inflated state, and from a fully inflated state to a partially inflated state.

According to the first aspect, when each of the air restriction bladders are in the fully inflated state, the air is prevented from entering the engine compartment through the grille.

According to the first aspect, when at least one of the air restriction bladders is in a partially inflated state, the amount of the air that is permitted to enter the engine compartment is reduced.

According to a second aspect of the present disclosure, there is provided an active grille shutter assembly configured to be provided between a grille and an engine compartment of a vehicle. The active grille shutter assembly may include a pump configured to be provided proximate the engine compartment; a conduit configured to receive pressurized air from the pump; a plurality of independently controllable air restriction bladders that are in fluid communication with the conduit; a valve between each of the air restriction bladders and the conduit for controlling an amount of the pressurized air that is permitted to enter the respective air restriction bladder; and a controller in communication with and operable to control the pump and each of the valves, wherein the air restriction bladders are configured to be inflated by the pressurized air to either prevent the air from entering the engine compartment through the grille or reduce an amount of the air from entering the engine compartment through the grille.

According to the second aspect, the controller is configured to determine whether to open and close each of the valves and control operation of the pump based on a vehicle operating condition.

According to the second aspect, the vehicle operating condition is a velocity of the vehicle.

According to the second aspect, the vehicle operating condition is a temperature within the engine compartment.

According to the second aspect, each of the air restriction bladders are formed from a fabric material.

According to the second aspect, each of the air restriction bladders includes a return coil attached to the fabric material that is configured to return each of the air restriction bladders to a deflated state after the pressurized air is evacuated from the air restriction bladders.

According to the second aspect, each of the air restriction bladders, based on an instruction received by the respective valve from the controller, is movable from a deflated state to a partially inflated state, from a deflated state to a fully inflated state, from a partially inflated state to a fully inflated state, and from a fully inflated state to a partially inflated state.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of an example vehicle according to a principle of the present disclosure;

FIG. 2 is a schematic representation of the vehicle illustrated in FIG. 1, having an active grille shutter assembly according to a principle of the present disclosure;

FIG. 3 is a partial perspective view of the vehicle illustrated in FIG. 1 having a portion of the grille removed to expose a conventional active grille shutter assembly;

FIG. 4 is a schematic illustration of an active grille shutter assembly according to a principle of the present disclosure in a fully open position;

FIG. 5 is a schematic illustration of the active grille shutter assembly according to a principle of the present disclosure in a fully closed position;

FIG. 6 is a schematic illustration of the active grille shutter assembly according to a principle of the present disclosure in a partially open position;

FIG. 7 is a schematic illustration of the active grille shutter assembly according to a principle of the present disclosure in another partially open position; and

FIGS. 8A to 8C are cross-sectional views of one of the air restriction bladders in a deflated condition, partially inflated condition, and fully inflated condition, respectively.

Corresponding reference numerals indicate corresponding parts throughout the several views of the drawings.

### DETAILED DESCRIPTION

Example embodiments will now be described more fully with reference to the accompanying drawings. The example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

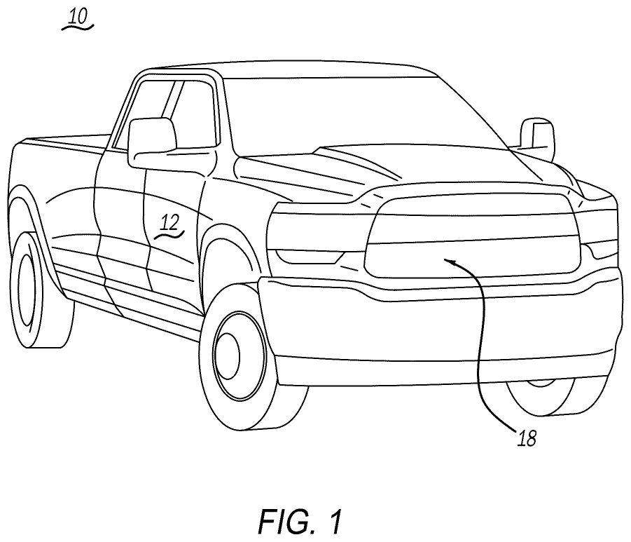

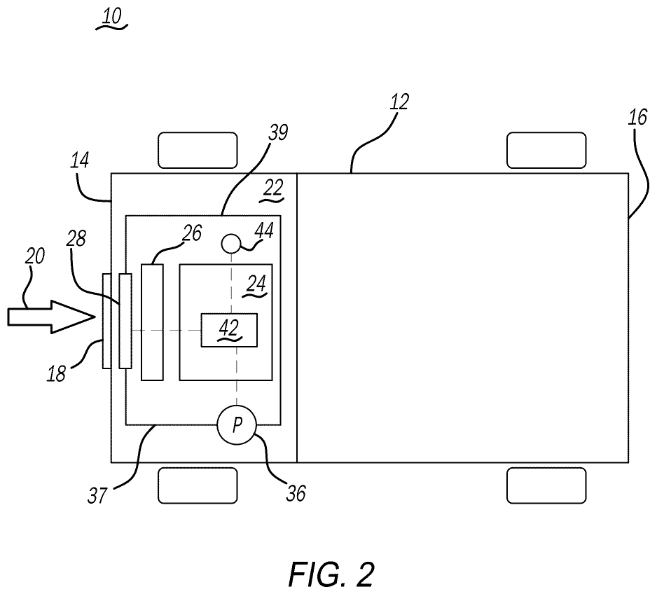

An example vehicle 10 according to the present disclosure is illustrated in FIGS. 1 and 2. Referring to FIGS. 1 and 2, vehicle 10 includes a body 12 having a front end 14 and a rear end 16. Front end 14 includes a grille 18 for permitting air 20 to enter an engine compartment 22, which may house a propulsion system 24 and heat exchanger 26. Propulsion system 24 may be an internal combustion engine (ICE) or an electric drive module (EDM), without limitation. During operation of vehicle 10, the air 20 passes through the grille 18 and the air 20 can be used to cool the propulsion system 24 as well as exchange heat with a fluid (not shown) passing through the heat exchanger 26, as is known in the art.

When vehicle 10 is operating at low velocities (e.g., under 25 mph) or stopped, there is a need for an increased amount of the air 20 passing through grille 18 into engine compartment 22 in comparison to when vehicle 10 is operating at a greater velocity (e.g., above 25 mph). In this regard, when vehicle 10 is travelling at an elevated velocity (e.g., above 25 mph), the air 20 does not necessarily need to pass through grille 18 in order to enter the engine compartment 22 because a greater volume of the air 20 passing beneath vehicle 10 can enter the engine compartment 22 from below.

Inasmuch as the air 20 does not necessarily need to pass through the grille 18 when vehicle 10 is travelling at elevated velocities, it may be desirable to restrict or prevent the amount of air 20 that can pass through the grille 18 to reduce the amount of aerodynamic drag experienced by vehicle 10 at the elevated velocities when the air 20 passes through the grille 18 and contacts the components (e.g., heat exchanger 26, propulsion system 24, and other vehicle components (not shown)) that are located in engine compartment 22. Thus, vehicle 10 may include an active grille shutter assembly 28 that is positioned between grille 18 and heat exchanger 26, which may be a condenser for a vehicle HVAC system, a radiator, or any other type of heat exchanger (e.g., evaporator) known in the art.

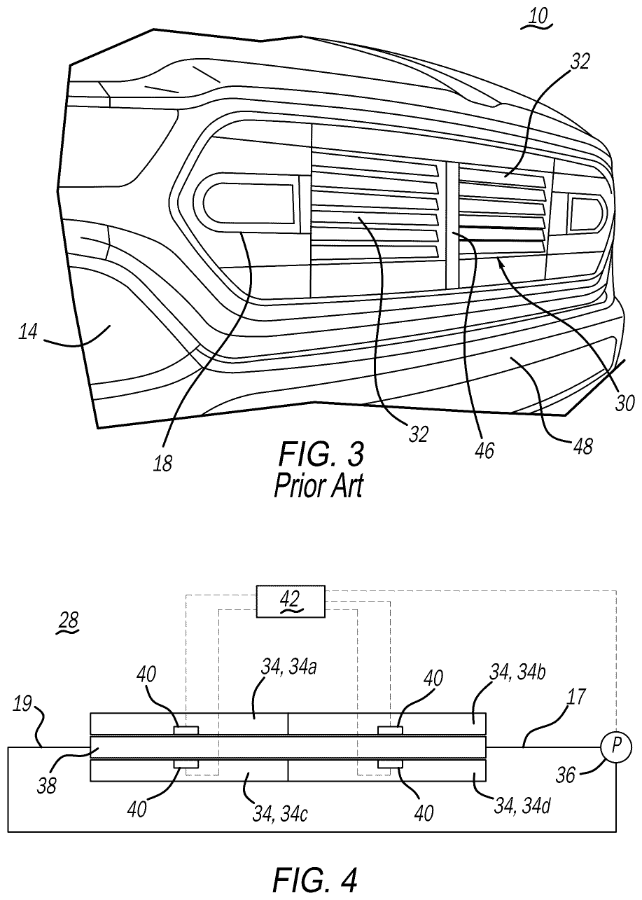

An example conventional active grille shutter assembly 30 is illustrated in FIG. 3, which is a partial perspective view of front end 14 of vehicle 10 having a portion of the grille 18 removed so that various features of the conventional active grille shutter assembly 30 are visible. The conventional active grille shutter assembly 30 includes a plurality of movable vanes or louvers 32, which in FIG. 3 are in an open position that permits ambient air that passes through grille 18 to flow through the active grille shutter assembly 30 and enter the engine compartment 22. The louvers 32 are actuated by at least one motor (not shown) that is in communication with a controller (not shown). When various vehicle operating conditions exist (i.e., vehicle velocity), the controller may instruct the motor(s) to move the louvers 32 from the open position (illustrated) to a closed position (not shown) such that air that passes through the grille 18 is restricted or prevented from passing between the louvers 32 and entering the engine compartment 22. When the air is restricted from passing between the louvers 32 and entering the engine compartment 22, the air will be forced overtop and beneath the vehicle 10 rather than entering the engine compartment 22 and contacting the components of the vehicle 10 located within the engine compartment 22. Put another way, the aerodynamic drag associated with vehicle 10 will be reduced, which can increase the fuel efficiency of the vehicle 10 and/or reduce the draw on the battery (if vehicle 10 is an electric vehicle) associated with moving the vehicle 10 at elevated velocities to extend a range of the vehicle 10.

It should be understood, however, that the motors associated with operating the louvers 32 can increase the weight of the vehicle 10, the louvers 32 when in the open position still block airflow through the conventional active grille assembly 30 at least to some extent, and that the louvers 32 may be undesirably visible through the grille 18 when in either the open or closed positions. In addition, the louvers 32 are not individually movable and, therefore, the conventional active grille assembly 30 is limited in the number of positions between the fully open and fully closed positions, which can inhibit the vehicle 10 from fully realizing the aerodynamic benefits that can be associated with operation of the conventional active grille assembly 30.

In view of the above, referring to FIGS. 4-7 and with continued reference to FIG. 2, the active grille shutter assembly 28 according to the present disclosure includes a plurality of air restriction bladders 34 that when inflated are operable to restrict or prevent airflow through the active grille shutter assembly 28 and improve the aerodynamic properties of vehicle 10, and when deflated are operable to permit airflow through the active grille shutter assembly 28 and into engine compartment 22. Air restriction bladders 34 are configured to be inflated using a compressor or pump 36 that may be part of an air-suspension system (not shown) of vehicle 10. By using a pump 36 that is already part of the vehicle architecture to inflate the air restriction bladders 34, no motors are necessary to operate the active grille shutter assembly 28 and a mass of vehicle 10 can be reduced. It should also be understood that pump 36 may be replaced by a compressed air storage tank, if desired.

FIGS. 4-7 illustrate an example configuration for air restriction bladders 34. While four air restriction bladders 34a-34d are illustrated, it should be understood that a greater or lesser number of air restriction bladders 34 can be utilized, if desired. Air restriction bladders 34 may be formed of a fabric material that is similar to that used for a vehicle airbag. For example, air restriction bladders 34 may be formed from a woven fabric that may be coated or uncoated, impermeable to gases, and flame resistant. An example woven fabric may be a polyamide (e.g., NYLON®) textile.

FIG. 4 illustrates the air restriction bladders 34 in a deflated condition, which corresponds to a fully open position of the active grille shutter assembly 28 such that a maximum amount of air 20 is permitted to pass through the grille 18 and enter the engine compartment 22 therethrough. In the illustrated embodiment, air restriction bladders 34 are in fluid communication with a conduit 38 that receives pressurized air from pump 36 via an inlet line 37, and returns unused pressurized air back to pump 37 via a return line 39. When conduit 38 is pressurized by pump 36, the flow of air into air restriction bladders 34 can be controlled by valves 40 that are positioned between conduit 38 and each air restriction bladder 34. Valves 40 may be, for example, solenoid valves that can control an amount of air that can enter each air restriction bladder 34. As illustrated, valves 40 are in communication with a controller 42 that may be, for example, an engine control unit (ECU) that is part of propulsion system 24, or may be a controller that is separate from the ECU. Valves 40 can be opened and closed based on signals received from controller 42. Moreover, because each air restriction bladder 34 includes a dedicated valve 40, air restriction bladders 34 are configured to be individually and dynamically controlled based on operating conditions of vehicle 10 by controller 42. When air restriction bladders 34 are in the deflated condition, pump 36 is not in operation.

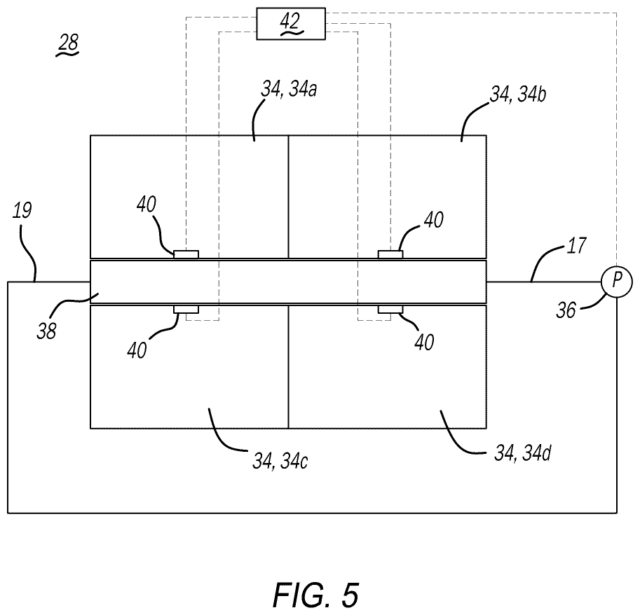

FIG. 5 illustrates air restriction bladders 34 in a fully inflated condition, which corresponds to a fully closed position of the active grille shutter assembly 28 such that no air or at least substantially no air 20 is permitted to pass through the grille 18 and enter the engine compartment therethrough. To fully inflate air restriction bladders 34, controller 42 can instruct pump 36 to operate and push air through inlet line 37 to conduit 38, as well as instruct valves 40 to fully open and permit the greatest amount of compressed air to enter the air restriction bladders 34 from conduit 38. When active grille shutter assembly 28 is in the fully closed position, the air 20 is forced to flow overtop and beneath vehicle 10, which improves the aerodynamic properties of vehicle 10 to thereby increase fuel efficiency and/or reduce the draw on the battery to extend a range of vehicle 10.

Controller 42 may instruct pump 36 to operate and instruct valves 40 to open based on various operating conditions of vehicle 10. For example, as noted above, if vehicle 10 is travelling at velocity that is less than a predetermined threshold (e.g., 25 mph), there is an increased need for the air 20 to be able to pass through grille 18 and active grille shutter assembly 28. Thus, controller 42 will not operate pump 36 or instruct pump 36 to cease operation, and instruct valves 40 to fully open to fully deflate air restriction bladders 34 (FIG. 4) and permit the air 20 to pass through grille 18 and active grille shutter assembly 28.

In contrast, if vehicle 10 is travelling at a substantial velocity that is greater than a predetermined threshold (e.g., 40 mph), controller 42 may instruct pump 36 to operate and instruct valves 40 to fully open to fully inflate air restriction bladders 34 (FIG. 5). When air restriction bladders 34 are each fully inflated, the air 20 is prevented or at least substantially restricted from passing through active grille shutter assembly 28, and the air 20 is forced to pass overtop and beneath vehicle 10. Thus, the aerodynamic properties of vehicle 10 are improved, which increases fuel efficiency and/or reduces the draw on the battery to extend a range of vehicle 10.

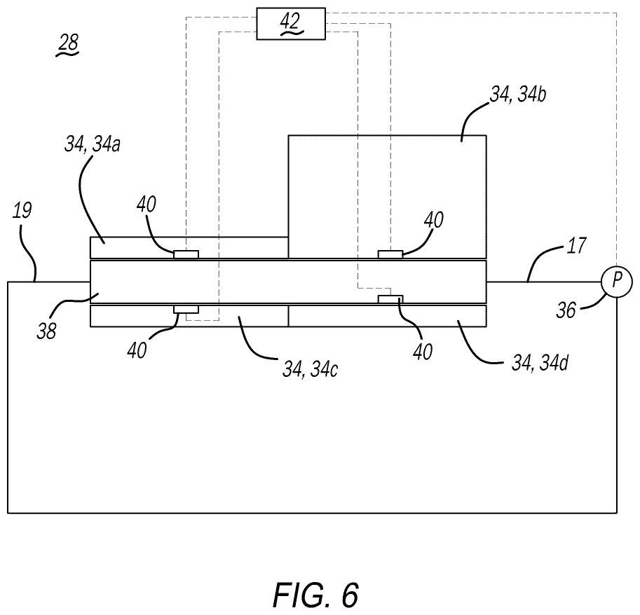

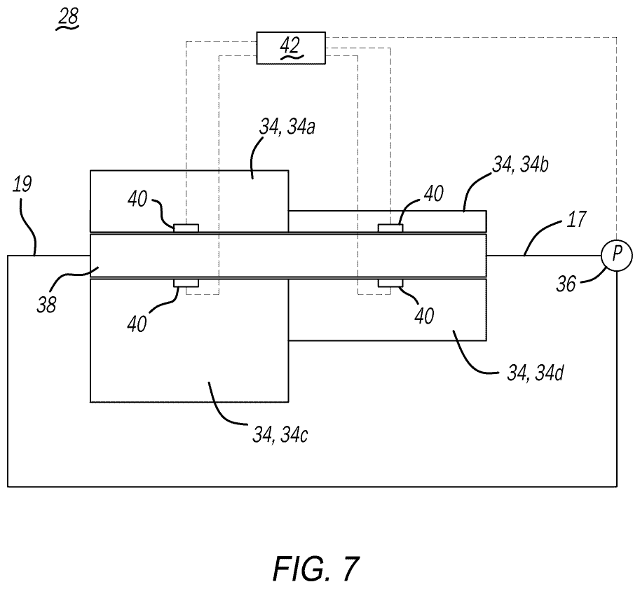

Active grille shutter assembly 28 is not limited to the fully closed (FIG. 5) and fully open (FIG. 4) positions. Indeed, as noted above, because each air restriction bladder 34 includes a dedicated valve 40 that is operable based on instructions received from controller 42, air restriction bladders 34 are configured to be individually and dynamically controlled based on operating conditions of vehicle 10 by controller 42. Moreover, because valves 40 may be solenoid valves, valves 40 can be actuated to a plurality of different positions such that the valves 40 can be fully closed, fully open, and partially open, which enables air restriction bladders 34 to be inflated to a position that is between fully closed and fully open (i.e., partially inflated) FIGS. 6 and 7 illustrate various examples of active grille shutter assembly 28 in partially open positions.

FIG. 6 illustrates a partially open position of active grille shutter assembly 28 where only air restriction bladder 34b has been inflated, and the remaining air restriction bladders 34a, 34c, and 34d are fully deflated. Air restriction bladder 34b was inflated by controller 42 instructing pump 36 to operate, and instructing valve 40 that is dedicated to air restriction bladder 34b to fully open. The configuration in FIG. 6 can be selected based on various operating conditions of vehicle 10. For example, vehicle 10 may be travelling at a velocity between 25 mph and 40 mph. When travelling at such a velocity, it may be desirable for vehicle 10 to have increased aerodynamic properties to improve fuel efficiency and/or reduce the draw on the battery, while at the same time vehicle 10 may require that the at least some of air 20 be permitted to pass through the active grille shutter assembly 28 to provide cold air to heat exchanger 26 and propulsion system 24. While only air restriction bladder 34b is shown as being fully inflated, it should be understood that any of air restriction bladders 34 can be selected to achieve the partially open position shown in FIG. 6. Moreover, it should be understood more than one of the air restriction bladders 34 (e.g., 2 or 3) can be fully inflated while one or more of the air restriction bladders 34 are deflated.

FIG. 7 illustrates another partially open position of active grille shutter assembly 28. In the configuration illustrated in FIG. 7, it can be seen that air restriction bladder 34a has been partially inflated, air restriction bladder 34b is fully deflated, air restriction bladder 34c is fully inflated, and air restriction bladder 34d is partially inflated. Air restriction bladders 34a, 34c, and 34d were inflated by controller 42 instructing pump 36 to operate, and instructing valve 40 that is dedicated to air restriction bladder 34a to partially open, instructing valve 40 that is dedicated to air restriction bladder 34c to fully open, and instructing valve 40 that is dedicated to air restriction bladder 34d to partially open.

The configuration in FIG. 7 can be selected based on various operating conditions of vehicle 10. For example, vehicle 10 may be travelling at a velocity between 25 mph and 40 mph. When travelling at such a velocity, it may be desirable for vehicle 10 to have increased aerodynamic properties to improve fuel efficiency and/or reduce the draw on the battery, while at the same time vehicle 10 may require that the at least some of air 20 be permitted to pass through the active grille shutter assembly 28 to provide cold air to heat exchanger 26 and propulsion system 24. The important aspect to keep in mind when viewing FIG. 7 is that air restriction bladders 34 can be partially inflated, if desired, by controller 42 instructing the valve 40 associated with an air restriction bladder 34 to only partially open, and that any of the air restriction bladders 34 can be independently operated in this manner.

While operation of active grille shutter assembly 28 has been described above as being controlled based on a velocity of vehicle 10, it should be understood that other vehicle operating conditions can be used as the basis for controlling operation of active grille shutter assembly 28. For example, again referring to FIG. 2, it can be seen that engine compartment 22 may have a temperature sensor 44 positioned therein in communication with controller 42 for generating signals indicative of temperature within engine compartment 22. Based on the signals indicative of temperature transmitted by temperature sensor 44 to controller 42, controller 42 can determine that engine compartment 22 is at a temperature that may require additional air 20 to enter the engine compartment 22 to exchange heat with heat exchanger 26 and/or be used to cool propulsion system 24 or some other component located in engine compartment 22. For example, even if vehicle 10 is operating at an elevated velocity that would otherwise cause active grille shutter assembly 28 to close, controller 42 may determine that air 20 is needed in engine compartment 22 and instruct pump 36 to operate and instruct at least one of the valves 40 to at least partially close to permit air 20 to pass through the active grille shutter assembly 28.

When air restriction bladders 34 are in the deflated state (FIG. 4), it should be understood that active grille shutter assembly 28 may be hidden from view. That is, for example, the air restriction bladders 34 and conduit 38 may be positioned behind a support structure 46 (FIG. 3) of grille 18. When conduit 38 is hidden behind support structure 46, it should be understood that air restriction bladders 34 will deploy (i.e., inflate) in lateral directions (i.e., side-to-side) from conduit 38, rather than in the up/down directions shown in FIGS. 4-7. Alternatively, conduit 38 may be hidden behind a bumper 48 of vehicle 10, or any other location that can conceal the active grille shutter assembly 28 when the assembly 28 is not in a deployed state. In such a case, it may be desirable that only a single air restriction bladder 34 be attached to conduit 38 that extends along an entire length of conduit 38 such that the single air restriction bladder 34 operates as a curtain that can permit and restrict the air 20 from entering engine compartment 22, where the curtain can have a non-deployed position, partially deployed position, and fully deployed position.

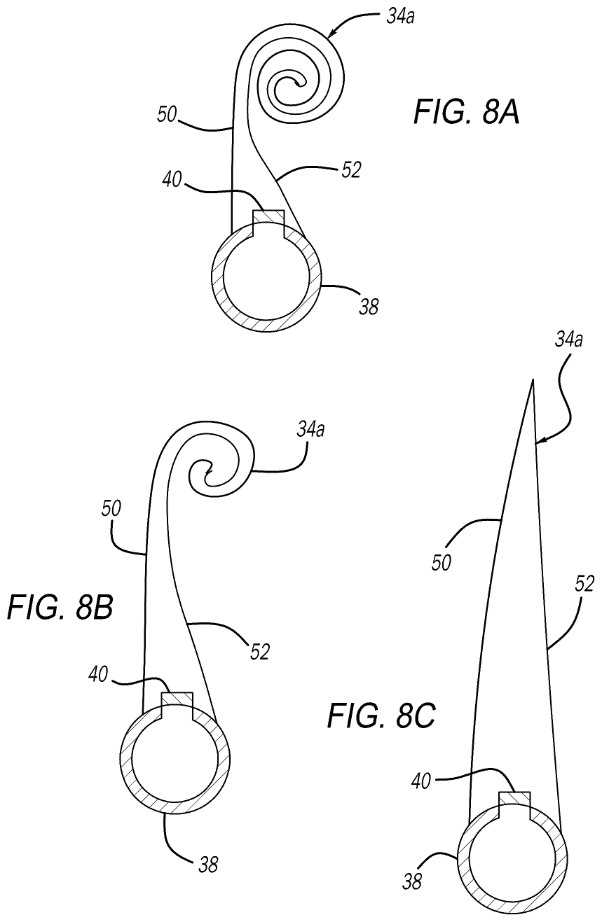

To ensure that air restriction bladders 34 may return to a deflated state (FIG. 4) from any of the inflated states shown in FIGS. 5-7, the air restriction bladders 34 may include a return coil 50 sewn into the fabric 52 as shown in FIGS. 8A-8C. Return coil 50 may be formed of a metal material such as steel, aluminum, or any other type of rigid material known to one skilled in the art. As can be seen in FIG. 8A, air restriction bladders 34 are rolled when in the deflated state. FIGS. 8B and 8C illustrate how the air restriction bladders 34 inflate to a partially inflated position (FIG. 8B) and fully inflated position (FIG. 8C) where the air pressure permitted to enter the air restriction bladders 34 via valves 40 is sufficient to un-coil the return coil 50 and permit the air restriction bladders 34 to extend outward from conduit 38. When valves 40 are fully opened and pump 36 ceases operating, air in the air restriction bladders 34 may exit the air restriction bladders 34 through valves 40 such that no pressure remains in the bladders 34 and the return coil 50 may return to a coiled state, which moves the air restriction bladder 34 back to the deflated and coiled state shown in FIG. 8A.

While air restriction bladders 34 have been described above as being useful for permitting, limiting, or restricting air flow into engine compartment 22 to control aerodynamic properties of vehicle 10 during various operating conditions, it should also be understood that air restriction bladders 34 may also be used to inhibit other materials (e.g., snow) from entering engine compartment 22 during operation of vehicle 10. In this regard, in temperature conditions that are around freezing, it may not be important to permit air flow into engine compartment 22 at lower vehicle velocities. It may be important, however, to restrict entry of snow into engine compartment that can melt and subsequently freeze. Thus, it should be understood that air restriction bladders 34 can be inflated at least to some extent to limit the ingress of materials such as snow, rain, dust, and the like as desired.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A vehicle comprising:
a vehicle body having a front end that defines an engine compartment for a propulsion system of the vehicle;
a grille provided at the front end that is configured to permit air to enter the engine compartment; and
an active grille shutter assembly provided between the grille and the engine compartment, wherein the active grille shutter assembly includes a conduit configured to receive pressurized air from a pump, a plurality of independently controllable air restriction bladders that are in fluid communication with the conduit and configured to receive the pressurized air from the conduit to inflate the air restriction bladders and either prevent the air from entering the engine compartment through the grille or reduce an amount of the air from entering the engine compartment through the grille.

2. The vehicle according to claim 1, wherein each air restriction bladder includes a valve that is operable to permit and prevent the pressurized air from entering the respective air restriction bladder.

3. The vehicle according to claim 2, further comprising a controller in communication with and configured to control each of the valves and the pump.

4. The vehicle according to claim 3, wherein the controller is configured to determine whether to open and close each of the valves and control operation of the pump based on a vehicle operating condition.

5. The vehicle according to claim 4, wherein the vehicle operating condition is a velocity of the vehicle.

6. The vehicle according to claim 4, wherein the vehicle operating condition is a temperature within the engine compartment.

7. The vehicle according to claim 1, wherein each of the air restriction bladders are formed from a fabric material.

8. The vehicle according to claim 7, wherein each of the air restriction bladders includes a return coil attached to the fabric material that is configured to return each of the air restriction bladders to a deflated state after the pressurized air is evacuated from the air restriction bladders.

9. The vehicle according to claim 3, wherein each of the valves is a solenoid valve that is operable, based on an instruction received from the controller, to adjust an amount of the pressurized air that is permitted to enter the respective air restriction bladder.

10. The vehicle according to claim 9, wherein each of the air restriction bladders, based on an instruction received by the respective valve from the controller, is movable from a deflated state to a partially inflated state, from a deflated state to a fully inflated state, from a partially inflated state to a fully inflated state, and from a fully inflated state to a partially inflated state.

11. The vehicle according to claim 10, wherein when each of the air restriction bladders are in the fully inflated state, the air is prevented from entering the engine compartment through the grille.

12. The vehicle according to claim 10, wherein when at least one of the air restriction bladders is in a partially inflated state, the amount of the air that is permitted to enter the engine compartment is reduced.

13. An active grille shutter assembly configured to be provided between a grille and an engine compartment of a vehicle, comprising:
a pump configured to be provided proximate the engine compartment;
a conduit configured to receive pressurized air from the pump;
a plurality of independently controllable air restriction bladders that are in fluid communication with the conduit;
a valve between each of the air restriction bladders and the conduit for controlling an amount of the pressurized air that is permitted to enter the respective air restriction bladder; and
a controller in communication with and operable to control the pump and each of the valves,
wherein the air restriction bladders are configured to be inflated by the pressurized air to either prevent the air from entering the engine compartment through the grille or reduce an amount of the air from entering the engine compartment through the grille.

14. The active grille shutter assembly according to claim 13, wherein the controller is configured to determine whether to open and close each of the valves and control operation of the pump based on a vehicle operating condition.

15. The active grille shutter assembly according to claim 14, wherein the vehicle operating condition is a velocity of the vehicle.

16. The active grille shutter assembly according to claim 14, wherein the vehicle operating condition is a temperature within the engine compartment.

17. The active grille shutter assembly according to claim 13, wherein each of the air restriction bladders are formed from a fabric material.

18. The active grille shutter assembly according to claim 17, wherein each of the air restriction bladders includes a return coil attached to the fabric material that is configured to return each of the air restriction bladders to a deflated state after the pressurized air is evacuated from the air restriction bladders.

19. The active grille shutter assembly according to claim 13, wherein each of the air restriction bladders, based on an instruction received by the respective valve from the controller, is movable from a deflated state to a partially inflated state, from a deflated state to a fully inflated state, from a partially inflated state to a fully inflated state, and from a fully inflated state to a partially inflated state.
